(19) United States
(12) Patent Application Publication
(10) Pub. No.: US 2023/0256457 A1
(43) Pub. Date: Aug. 17, 2023

(54) FLOTATION ARRANGEMENT AND METHOD RELATED THERETO

(71) Applicant: Metso Outotec Finland Oy, Tampere (FI)

(72) Inventors: Ian Sherrell, Tampere (FI); Antti Rinne, Tampere (FI); Antti Mikael MÄKELÄ, Tampere (FI)

(73) Assignee: Metso Outotec Finland Oy, Tampere (FI)

(21) Appl. No.: 18/012,263

(22) PCT Filed: Jun. 23, 2021
(86) PCT No.: PCT/FI2021/050488

§ 371 Date: Dec. 22, 2022

Related U.S. Application Data
(60) Provisional application No. 63/046,092, filed on Jun. 30, 2020.

(51) Int. Cl. B03D 1/02; B03D 1/10; B03D 1/24; B03D 1/16

(52) U.S. Cl. CPC B03D 1/02; B03D 1/10; B03D 1/242; B03D 1/16; B03D 2203/02

(57) ABSTRACT

A flotation arrangement, a flotation plant and a method related thereto are disclosed. The flotation arrangement includes a first flotation section and a second flotation section. The arrangement further includes a dewatering system for separating solid material and liquid to obtain a dewatered solid material stream and a separated liquid stream, and the dewatering system is arranged before the second flotation section and connected thereto for leading said dewatered solid material stream to the second flotation section and the arrangement includes recovery means for recovering the separated liquid stream.

### FIELD OF TECHNOLOGY

This disclosure concerns mineral processing. In particular, this disclosure concerns separation of minerals from their ores by flotation.

### BACKGROUND

The energy consumption of comminution processes, especially grinding, typically constitutes a significant part of overall energy consumption in mineral processing. As such, significant effort has been invested in reducing energy consumption of grinding. This may generally be achieved by lowering the degree of liberation of ore, i.e. by increasing the average size of ore particles prior to concentration. Robust so called standard mechanical flotation units are best suited for separation of particles within a size range of approximately 20 μm to 150 μm. Consequently, alternative solutions are required to increase the recovery of average particle size of ore beyond 150 μm.

In light of this, it may be desirable to develop new solutions related to separation of coarser particles.

Generally, there is a need for improving the efficiency of the flotation in processes for liberating valuable minerals from mineral ore.

### SUMMARY

The flotation arrangement according to the current disclosure is characterized by what is presented in claim 1.

The flotation plant according to the current disclosure is characterized by what is presented in claim 20.

Further, the method according to the current disclosure is characterized by what is presented in claim 22.

The grinding of the ore before flotation gives a rather uneven result, i.e. it gives a wide range of particles of different sizes. Provided is a flotation arrangement, which is able to handle and recover a broad particle size distribution of particles containing both finer and coarser particles in an energy and water efficient way. By first treating the ore using a robust first flotation unit, and then removing and recovering excess water before the ore is treated in a second flotation unit, an arrangement providing an energy and water efficient flotation method may be achieved.

### Definitions

This summary of definitions is provided to introduce a selection of concepts in a simplified form that are further described below in the detailed description. This summary is not intended to identify key features or essential features of the claimed subject matter, nor is it intended to be used to limit the scope of the claimed subject matter.

Throughout this specification, “flotation” may refer to separation of a mixture by adhering a substance in said mixture at an interface. In flotation, separation of a mixture may be based on differences in the hydrophobicity of substances in said mixture. Herein, “separation” may refer to the extraction or removal of a substance from a mixture for use or rejection.

Further, “froth” may refer to a dispersion, comprising a greater portion by volume of flotation gas dispersed as bubbles in lesser portion by volume of a flotation liquid. Generally, froth may or may not be stabilized by solid particles.

In this disclosure, a “layer” may refer to a generally sheet-formed element arranged on a surface. A layer may or may not be path-connected. Some layers may be locally path-connected and disconnected. Although a layer may generally comprise a plurality of sublayers of different material compositions, a “froth layer” may refer to a layer comprising, or comprising substantially, or consisting essentially of, or consisting of froth.

Throughout this specification, slurry being “fed to a froth layer” may refer to feeding said slurry onto, and/or into, and/or immediately below, e.g., at most 50 cm, or at most 40 cm, or at most 30 cm, or at most 20 cm, or at most 10 cm below, said froth layer. Additionally or alternatively, in embodiments, wherein a height of a launder lip defines a height of an upper surface of a froth layer, slurry being fed to said froth layer may refer to feeding said slurry into a tank at said launder lip height and/or at a position at most 60 cm, or at most 50 cm, or at most 40 cm, or at most 30 cm, or at most 20 cm below said launder lip height.

Herein, a “unit” may refer to a device suitable for or configured to perform at least one specific process. Naturally, a “flotation unit” may then refer to a unit suitable for or configured to subject material to flotation. A unit may generally comprise one or more parts, and each of the one or more parts may be classified as belonging to an arrangement of said unit.

A “device” may refer to a set of parts of said unit suitable for or configured to perform at least one specific subprocess of said process. Generally, a device may comprise any component(s), for example, mechanical, electrical, pneumatic, and/or hydraulic component(s), necessary and/or beneficial for performing its specific subprocess.

In this disclosure, “a means for creating bubbles” is an arrangement for providing flotation gas and may refer to an arrangement of parts of a flotation unit suitable for or configured to supply flotation gas into a tank of said flotation unit. Generally, a flotation gas supply arrangement may comprise any part(s) suitable or necessary for supplying flotation gas into a tank, for example, one or more spargers, e.g., jetting and/or cavitation sparger(s), and/or one or more static mixers.

In this specification, a “tank” may refer to a receptacle suitable for or configured to hold a fluid, for example, a liquid.

Further, “slurry” may refer to a dispersion, comprising solid particles suspended in a continuous phase of flotation liquid. As such, a “volume of slurry” may refer to a certain amount of slurry. In flotation, slurry may be commonly referred to as coarse slurry or as fine slurry depending on its properties.

Throughout this specification, “classification” may refer to sizing of solid particles in slurry to form at least two, i.e., two, three, or more, slurry fractions based on differences in the settling velocities of solid particles in said slurry. In practice, classification of slurry results in coarser particles in said slurry being preferentially directed to one or more coarser slurry fractions and finer particles in said slurry being preferentially directed to one or more finer slurry fractions.

Throughout this specification, a “agitation” may refer stirring, mixing and/or disturbing a fluid, e.g., a liquid or a slurry.

Throughout this disclosure, a “fluidized-bed” may refer to a solid-fluid mixture, which exhibits fluid-like properties. As known to the skilled person, a fluidized bed may be maintained by passing pressurized fluid(s), i.e., liquid(s) and/or gas(es), through a particulate medium.

Consequently, “fluid bed flotation” or “fluidized-bed flotation” may refer to flotation, wherein a fluid bed/fluidized bed is maintained in a volume of slurry by suitably passing flotation liquid and/or flotation gas through said volume of slurry, and a “fluidized-bed flotation unit” may refer to a unit suitable for or configured to subject material to fluidized-bed flotation.

Generally, maintaining a fluidized bed in a tank of a flotation unit may increase recovery of coarser particles. Additionally or alternatively, when coarse slurry is fed to a froth layer for froth-interaction flotation and a fluidized bed is maintained in a volume of slurry below said froth layer, coarser particles of said coarse slurry that have inadvertently dropped into said volume of slurry may settle through said fluidized bed and may be recollected more efficiently to the froth layer.

Throughout this specification, a “dewatering system” refers to a solid-liquid separation arrangement. A solid-liquid separation arrangement may comprise one or more of a dewatering cyclone, a gravitational sedimentation device, e.g., a thickener or a inclined plate settler; a centrifuge; and a filtration device, e.g., a pressure filter, a tube press, a vacuum filter, or a rotary-drum filter. Preferably, the dewatering system comprises a dewatering cyclone. The dewatering system, such as especially a dewatering cyclone, used in combination with a robust first standard flotation section is advantageous, when the dewatering system is located after the first section and before the second flotation section. The standard flotation system evens the stream and minimizes variations in the mass fed to the dewatering system. This may solve many problems.

### BRIEF DESCRIPTION OF THE DRAWINGS

The present disclosure will be better understood from the following detailed description read in light of the accompanying drawings, wherein:

FIG. 1 shows a schematic view of the flotation arrangement of this disclosure.

FIG. 2 shows a schematic view of the flotation arrangement of this disclosure.

FIG. 3 shows a schematic view of the flotation arrangement of this disclosure.

Unless specifically stated to the contrary, any drawing of the aforementioned drawings may be not drawn to scale such that any element in said drawing may be drawn with inaccurate proportions with respect to other elements in said drawing in order to emphasize certain structural aspects of the embodiment of said drawing.

Moreover, corresponding elements in the embodiments of any two drawings of the aforementioned drawings may be disproportionate to each other in said two drawings in order to emphasize certain structural aspects of the embodiments of said two drawings.

### DETAILED DESCRIPTION

Generally, in standard flotation such as standard mechanically agitated flotation cells, underflow from a first primary flotation unit may comprise considerable amounts of coarser particles of valuable mineral(s) mixed with finer gangue particles. Standard mechanical flotation cells only separate effectively within a narrow size range of approximately 20 microns to 150 microns depending on the ore type and the liberation of the ore, and may vary. Thus, coarser particles are not fully recovered by these standard flotation units. This can result in a substantial loss of valuable coarse minerals. One application of so called “coarse flotation” is treatment of the tailings or an underflow stream to increase the overall recovery of valuable material. This may be fresh tailings from the ongoing current process or from reclaimed tailings ponds. Any captured minerals from the tailings stream may then be reground and subjected to further standard flotation to improve product grade. However, this is energy consuming. Excessive classification devices can be utilized, which also are energy consuming.

The current disclosure describes an arrangement, which provides an improvement by treating all solids within the underflow stream from a first flotation section within a second flotation section, such as a coarse flotation unit. The stream may have relatively high percentage solids by weight before entering the second flotation unit. This is typically above 50 or 55 weight %, or above 65 weight-% solids. A higher solids content may enable improved efficiency of the second flotation section. In addition, the separated water can be utilized enabling savings in process water usage. Typically, the fresh tailings i.e. underflow from standard flotation contains rather high amounts of water, so parts of it can be separated. Thus, a dewatering stage and a dewatering system in combination with the first flotation unit (such as standard mechanically agitated flotation cells) and the second flotation unit (for coarser particles) provides an advantage. By optimizing the use of water, a cost-effective process for an industrial scale application may be achieved.

The dewatering system is not a classification system. The separated water may immediately be returned to the process water system, but could be needed further in the coarse flotation process.

Coarse flotation processes that can handle high percentages of solids in the feed are preferred. One such process is separation-in-froth or other froth interaction processes, or fluidized-bed flotation technology. The second flotation unit may require water to maintain its operations, and thus at least part of the water separated and recovered using the dewatering system may be utilized.

The benefits of the arrangement, plant and method of this disclosure include providing:
immediate recyclability and utilization of process water. The aim is to allow only minor amounts of solids is within the separated liquid/water stream.
Smaller unit size of the second flotation unit may be achieved by first using a robust first standard flotation system for removing a large mass of valuable material. Thus, the underflow from the first flotation system is significantly smaller than the feed to the first flotation system. In addition, water may be removed. Thus, a second so-called coarse flotation unit does not need to account for the high volume of water in typical flotation tailings. By utilizing the described combination of systems, the overall size of the equipment after the first flotation unit may be reduced.
No pre-classification units are typically needed. This reduces the upstream equipment requirements.

The arrangement, plant and method of this disclosure provides a way to control the water balance of the flotation process. Flotation uses large amounts of water, so water balance control is important. Robust standard flotation uses less water, so placing such a flotation section first optimizes the consumption and evens the stream. Separating and recovering the water before the second flotation unit (coarse flotation) gives an added effect. There is overall less material to be treated in the more water consuming second (coarse) flotation unit.

The separated and recovered water may be led to a process water system. I may also be recovered in a process water tank and/or tailings pond. Further, it may be recirculated directly to a specific unit, such as a flotation unit. Preferably, the second flotation unit comprising a fluid bed. The advantage is that the fluid bed can handle the coarse material well.

Thus, described is a flotation arrangement comprising:
a first flotation section including a first flotation unit (1) comprising a mechanical agitator, and
a second flotation section including a second flotation unit (2), which comprises
   i) a fluid bed device comprising devices for creating a fluid bed, and/or
   ii) a froth device comprising devices for creating a froth layer, wherein particles are fed for interaction with froth layer in the froth layer, under the froth layer close proximity thereof, or above the froth layer, or any combinations thereof,
   wherein the arrangement further comprises a dewatering system (3) for separating solid material and liquid to obtain a dewatered solid material stream (31) and a separated liquid stream (32), and said dewatering system is arranged before the second flotation unit (2) and connected thereto for leading said dewatered solid material stream (31) to the second flotation unit (2) and the arrangement comprises recovery means (33) for recovering the separated liquid stream (32).

According to one embodiment, the recovery means are arranged to lead at least part of the separated liquid stream (32) to the second flotation unit (2). Optionally, all or nearly all of the separated liquid stream may be led to the second flotation unit. The second flotation unit may be a so-called coarse flotation unit, which typically can require water. Thus, recovering and recirculating at least part of the water in the second flotation equipment may provide a very effective way of utilizing the water.

According to one embodiment, the first flotation unit (1) is
i) at least one device comprising a closed vessel for a pressurized flotation, wherein flotation concentrate is removed by pressure from the vessel, and/or
ii) at least one device comprising a flotation vessel and:
an inlet (11) connected for receiving feed to be handled in said flotation vessel and arranged to a lower part of the flotation vessel,
an overflow means for removing flotation concentrate, arranged to an upper part of the flotation vessel, and
an outlet (12) for removing underflow, arranged to a lower part of the flotation vessel. The described first flotation units may be so called standard flotation units, which represent robust technology.

According to one embodiment, the dewatering system (3) is a dewatering cyclone. A dewatering cyclone is a preferred effective dewatering device in the combination of sections as described herein.

According to one embodiment, the dewatering system is arranged to provide a solid material stream with a solids content of above 50 weight-%, preferably 60 to 80 weight-%, of the total weight of the stream.

According to one embodiment, the mechanical agitator comprises means for mixing a slurry and creating bubbles therein. The robust technology using mechanical agitation creates bubbles, which can remove particles with a large particle size distribution. Thus, the mass pull to the following sections is reduced and a rather homogenous underflow from the first flotation section can be provided.

According to one embodiment, the first flotation unit (1) comprises at least three flotation vessels arranged in series such that the outlet for removing underflow of a preceding flotation vessel is connected to the inlet of a following flotation vessel. Using at least three flotation vessels enables removing a large part of the valuable material efficiently. An example of suitable robust flotation vessels for the first flotation unit may be the so-called TankCell®. Treating the ore stream in several vessels may ensure maximum recovery of the valuable material in the first flotation section.

According to one embodiment, the first flotation unit comprises a flotation vessel and the flotation vessel comprises devices for creating a froth layer.

According to one embodiment, the second floatation unit comprises a fluid bed device comprising devices for creating a fluid bed. Since the coarse flotation uses large amounts of water, reducing the size of this equipment reduces the amount of water considerably. Recovering and utilizing the separated water stream from the dewatering system is especially advantageous when using a fluid bed, because creating the fluid bed requires a rather large water consumption, so controlling the water balance is especially important.

According to one embodiment, the second flotation unit comprises

i) a fluid bed device comprising devices for creating a fluid bed, and
ii) a froth device comprising devices for creating a froth layer, wherein particles are fed for interaction with froth layer in the froth layer, under the froth layer close proximity thereof, or above the froth layer, or any combinations thereof.

The advantage is of this embodiment is that a device combining these two technologies may recover an even larger amount of the coarse particles in the feed.

According to one embodiment, the first flotation unit (1) comprises at least one flotation vessel and the flotation vessel comprises a device comprising
an inlet connected for receiving feed to be handled in said flotation vessel and arranged to a lower part of the flotation vessel,
an overflow means for removing flotation concentrate, arranged to an upper part of the flotation vessel, and
an outlet for removing underflow, arranged to a lower part of the flotation vessel.

One example of such a flotation vessel is a TankCell®. The robust flotation technology described in this embodiment is suitable for many kinds of feed, since it does not easily clog. A rater large mass can be removed, so in case a mill is used its operation does not need to be very strictly adjusted, which facilitates operation of the flotation arrangement. In particular, the outlet for removing underflow enables the handling of a large range of different particle sizes before the second flotation unit.

According to one embodiment, the first flotation unit (1) comprises a flotation vessel and the flotation vessel comprises a closed vessel for a pressurized flotation, wherein flotation concentrate is removed by pressure from the vessel. The pressure enables moving the slurry/material to be handled up in the vessel and removing it. A very high amount of mass can be removed.

According to one embodiment, the arrangement further comprises a third flotation unit comprising a flotation vessel that comprises devices for pneumatical gas addition. When there is pneumatical gas addition, gas bubble size distribution can be adjusted according to required conditions. Small bubbles can be selected to remove small particles, after the mechanically agitated flotation arranged to remove mass largely and the second flotation to remove coarser particles. When there is separate pneumatical gas addition in the end of flotation system, process parameters can be selected in second flotation unit based on coarse particle need. Then coarse particle device can be small and requires less water. According to one specific embodiment, this flotation vessel comprises a froth separation device comprising devices for creating a froth layer, comprising
an inlet connected for receiving feed to be handled in said flotation vessel and arranged to an upper part of the flotation vessel, and
an overflow means for removing flotation concentrate, arranged to an upper part of the flotation vessel.

One example of this is a so-called column flotation cell. One advantage with this embodiment is that it can be used without screening or classification before the third flotation unit. It is able to process a rather broad range of particles, even coarse. The whole underflow from the second flotation unit may thus be led to the third flotation unit. For example, if there is only a very little amount of fine material to be removed, the third flotation unit of this embodiment is advantageous, because it can recover the finer material even if there is coarse material in the feed.

According to another very specific embodiment of an arrangement comprising a third flotation unit, the flotation vessel comprises a downcomer for slurry infeed, the downcomer equipped with a nozzle for feeding pressurized flotation gas in slurry therein. Furthermore, the flotation the downcomer may comprise an outlet nozzle configured to induce a supersonic shockwave into the slurry as it exits the downcomer. The flotation arrangement of this embodiment may also comprise a separation unit arranged for preventing large particles entering in the third flotation unit. Further, the separation unit may comprise a grizzly and/or a grating.

Described is also a flotation plant comprising the flotation arrangement according to any one of the embodiments described herein.

According to one embodiment, the flotation plant comprises a pre-milling section comprising a mill selected from the group consisting of an autogenous grinding mill, a semi-autogenous grinding mill, and a high-pressure grinding roll or any combination thereof. The combination of pre-milling, a first robust flotation section, the dewatering system and a second flotation section for coarse particles is especially effective. The standard flotation can handle the material from the pre-milling well and remove a large mass and even the stream (underflow). Thus, the dewatering system, such as especially a dewatering cyclone, can function better, when placed after the first section and before the second flotation section. Again, the dewatered stream fed to the second (coarse) flotation unit is more even. The combination can reduce the energy required for milling as there is no need to regrind all underflow from first flotation unit.

Further, described is a flotation method for separating valuable minerals from a slurry, wherein the method comprises the steps wherein
the slurry is treated in a first flotation section including a first flotation unit (1) comprising a mechanical agitator,
subsequently, the slurry is treated in a second flotation section including a second flotation unit (2), which comprises
   i) a fluid bed device comprising devices for creating a fluid bed, and/or
   ii) a froth device comprising devices for creating a froth layer, wherein particles are fed for interaction with froth layer in the froth layer, under the froth layer close proximity thereof, or above the froth layer, or any combinations thereof,
   wherein the method further comprises treating the slurry in a dewatering system (3) for separating solid material and liquid to obtain a dewatered solid material stream (31) and a separated liquid stream (32), and said dewatering system is arranged before the second flotation unit (2) and said dewatered solid material stream (31) is led to said second flotation unit (2) and the separated liquid stream (32) is recovered.

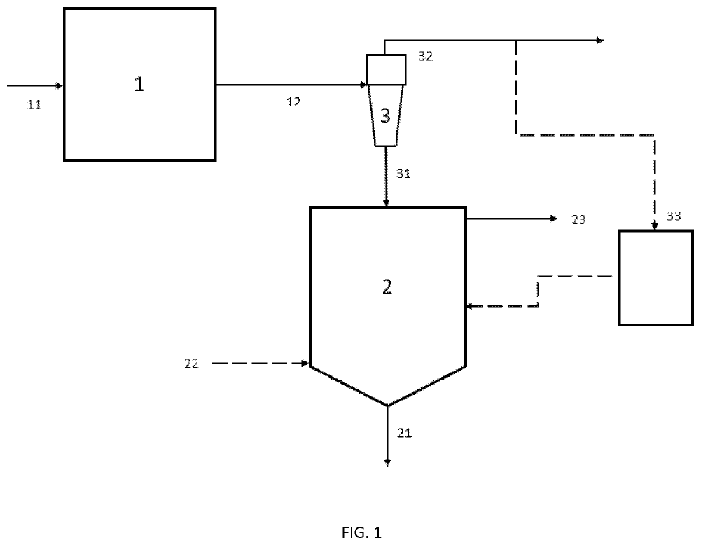

FIG. 1 illustrates one embodiment of the flotation arrangement of this disclosure. It shows a first flotation unit 1 and a second flotation unit 2. The arrangement also comprises a dewatering system 3 for separating solid material. The figure shows a dewatered solid material stream 31 and a separated liquid stream 32. The dewatering system 3 is arranged before the second flotation unit 2 and connected by leading the dewatered solid material stream 31 to the second flotation unit 2. The figure also shows that the arrangement includes recovery means 33 for recovering the separated liquid stream 32. An overflow comprising fines is led out from the second flotation unit via line 23. Additional water is optionally added to the second flotation unit via line 22.

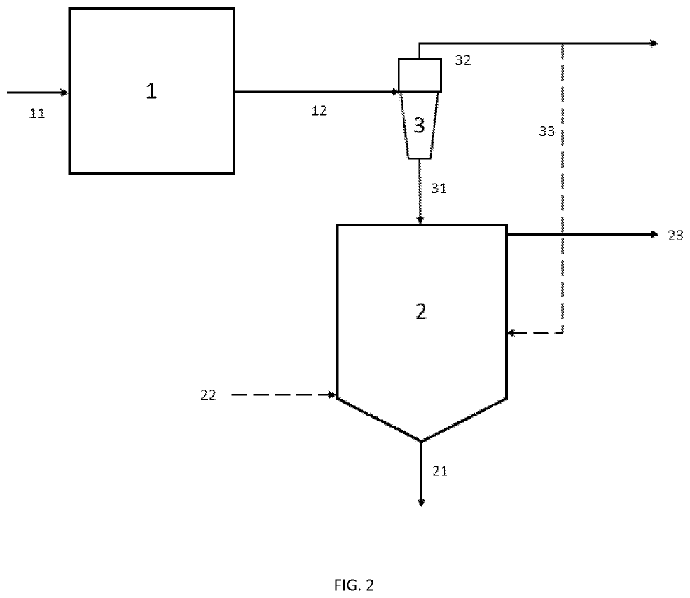

FIG. 2 illustrates another embodiment of the flotation arrangement of this disclosure. At least part of the separated and recovered liquid stream 33 is led directly to the second flotation unit 2.

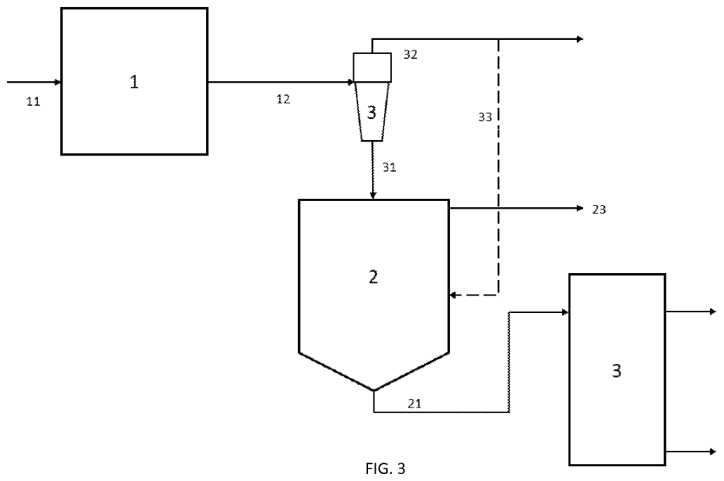

FIG. 3 illustrates another embodiment of the flotation arrangement of this disclosure. The arrangement further comprises a third flotation unit (3) and means for feeding the underflow 21 from the second flotation unit to the third flotation unit.

It will be understood that any benefits and advantages described above may relate to one embodiment or may relate to several embodiments. The embodiments are not limited to those that solve any or all of the stated problems or those that have any or all of the stated benefits and advantages.

The term “comprising” is used in this specification to mean including the feature(s) or act(s) followed thereafter, without excluding the presence of one or more additional features or acts. It will further be understood that reference to ‘an’ item refers to one or more of those items.

1. A flotation arrangement comprising:
a first flotation section including a first flotation unit comprising a mechanical agitator, and
a second flotation section including a second flotation unit, which comprises
i) a fluid bed device comprising devices for creating a fluid bed, and/or
ii) a froth device comprising devices for creating a froth layer, wherein particles are fed for interaction with froth layer in the froth layer, under the froth layer close proximity thereof, or above the froth layer, or any combinations thereof,
wherein the arrangement further comprises a dewatering system for separating solid material and liquid to obtain a dewatered solid material stream and a separated liquid stream, and said dewatering system is arranged before the second flotation unit and connected thereto for leading said dewatered solid material stream to the second flotation unit and the arrangement comprises recovery means for recovering the separated liquid stream.

2. The flotation arrangement according to claim 1, wherein the recovery means are arranged to lead at least part of the separated liquid stream to the second flotation unit.

3. The flotation arrangement according to claim 1, wherein the second floatation unit comprises a fluid bed device comprising devices for creating a fluid bed.

4. The flotation arrangement according to claim 1, wherein the second flotation unit comprises
i) a fluid bed device comprising devices for creating a fluid bed, and
ii) a froth device comprising devices for creating a froth layer, wherein particles are fed for interaction with froth layer in the froth layer, under the froth layer close proximity thereof, or above the froth layer, or any combinations thereof.

5. The flotation arrangement according to claim 1, wherein the first flotation unit is
i) at least one device comprising a closed vessel for a pressurized flotation, wherein flotation concentrate is removed by pressure from the vessel, and/or
ii) at least one device comprising a flotation vessel and:
an inlet connected for receiving feed to be handled in said flotation vessel and arranged to a lower part of the flotation vessel,
an overflow means for removing flotation concentrate, arranged to an upper part of the flotation vessel, and
an outlet for removing underflow, arranged to a lower part of the flotation vessel.

6. The flotation arrangement according to claim 1, wherein the dewatering system is a dewatering cyclone.

7. The flotation arrangement according to claim 1, wherein the dewatering system is arranged to provide a solid material stream with a solids content of above 50 weight-%, preferably 60 to 80 weight-%, of the total weight of the stream.

8. The flotation arrangement according to claim 1, wherein the mechanical agitator comprises means for mixing a slurry and creating bubbles therein.

9. The flotation arrangement according to claim 1, wherein the first flotation unit comprises at least three flotation vessels arranged in series such that the outlet for removing underflow of a preceding flotation vessel is connected to the inlet of a following flotation vessel.

10. The flotation arrangement according to claim 1, wherein the first flotation unit comprises a flotation vessel and the flotation vessel comprises devices for creating a froth layer.

11. The flotation arrangement according to claim 1, wherein the mechanical agitator comprises means for mixing a slurry and creating bubbles therein.

12. The flotation arrangement according to claim 1, wherein the first flotation unit comprises at least one flotation vessel and the flotation vessel comprises a device comprising
an inlet connected for receiving feed to be handled in said flotation vessel and arranged to a lower part of the flotation vessel,
an overflow means for removing flotation concentrate, arranged to an upper part of the flotation vessel, and
an outlet for removing underflow, arranged to a lower part of the flotation vessel.

13. The flotation arrangement according to claim 1, wherein the first flotation unit comprises a flotation vessel and the flotation vessel comprises a closed vessel for a pressurized flotation, wherein flotation concentrate is removed by pressure from the vessel.

14. The arrangement according to claim 1, wherein the arrangement further comprises a third flotation unit comprising a flotation vessel that comprises devices for pneumatical gas addition.

15. The arrangement as claimed in claim 14, wherein
the flotation vessel comprises a froth separation device comprising devices for creating a froth layer, comprising
an inlet connected for receiving feed to be handled in said flotation vessel and arranged to an upper part of the flotation vessel, and
an overflow means for removing flotation concentrate, arranged to an upper part of the flotation vessel.

16. The flotation arrangement as claimed in claim 14, wherein the flotation vessel comprises a downcomer for slurry infeed, the downcomer equipped with a nozzle for feeding pressurized flotation gas in slurry therein.

17. The flotation arrangement as claimed in claim 16, wherein
the downcomer comprises an outlet nozzle configured to induce a supersonic shockwave into the slurry as it exits the downcomer.

18. The flotation arrangement as claimed in claim 16, comprising
a separation unit arranged for preventing large particles entering in the third flotation unit.

19. The arrangement as claimed in claim 18, wherein
the separation unit comprises a grizzly or a grating.

20. A flotation plant comprising the flotation arrangement according to claim 1.

21. The flotation plant according to claim 20, wherein the plant comprises a pre-milling section comprising a mill selected from the group consisting of an autogenous grinding mill, a semi-autogenous grinding mill, and a high-pressure grinding roll or any combination thereof.

22. A flotation method for separating valuable minerals from a slurry, wherein the method comprises the steps of:
treating the slurry in a first flotation section including a first flotation unit comprising a mechanical agitator,
subsequently, treating the slurry in a second flotation section including a second flotation unit, which comprises
i) a fluid bed device comprising devices for creating a fluid bed, and/or
ii) a froth device comprising devices for creating a froth layer, wherein particles are fed for interaction with froth layer in the froth layer, under the froth layer close proximity thereof, or above the froth layer, or any combinations thereof,
wherein the method further comprises the step of treating the slurry in a dewatering system for separating solid material and liquid to obtain a de-watered solid material stream and a separated liquid stream, and said dewatering system is arranged before the second flotation unit and said dewatered solid material stream is led to said second flotation unit and the separated liquid stream is recovered.
